(19) United States
(12) Patent Application Publication
(10) Pub. No.: US 2005/0045508 A1
(43) Pub. Date: Mar. 3, 2005

(54) Storage apparatus

(76) Inventor: Po-Yu Lu, Taichung Hsien (TW)

Correspondence Address: BIRCH STEWART KOLASCH & BIRCH, PO BOX 747, FALLS CHURCH, VA, 22040-0747, US

(21) Appl. No.: 10/653,169

(22) Filed: Sep. 3, 2003

(51) Int. Cl. B62B 7/02; B62B 1/00

(52) U.S. Cl. 206/372; 206/349; 280/47.26

(57) ABSTRACT

A storage apparatus includes a box, a first cover and a second cover. The box can receive various tools. The first cover can cover the box. The first cover includes at least one hole defined therein so as to receive at least one tool. The second cover can cover the hole.

### FIELD OF INVENTION

The present invention relates to a storage apparatus.

### BACKGROUND OF INVENTION

Referring to U.S. Pat. No. 5,520,400 that was issued to the applicant of the present application on 28 May 1996, a storage apparatus is disclosed for a detachable jack. The storage apparatus includes a box 1 and a cover 2. The box 1 further includes a space (not shown) for receiving a casing A, a support B, an expander C, caps D, and steel columns E. The box 1 is equipped with two wheels 11. The cover 2 is pivotally connected with the box 1. The cover 2 includes a front side and a rear side. The front side of the cover 2 includes a beveled surface 22 formed thereon. Several recesses 23 are defined in the beveled surface 22 of the front side of the cover 2. The cover 2 includes several holes 24 defined therein. Each of the holes 24 extends from one of the recesses 23 to the rear side of the cover 2. The holes 24 are used for receiving columns E. Each of the recesses 23 includes a stop 231 formed thereon for preventing the columns E from escaping the holes 24. If the stops 231 are too short, they cannot adequately keep the columns E in the holes 24. However, if the stops 231 are too high, it is difficult for a user to take the columns E from the holes 24. Moreover, the recesses 23 are exposed so that dusts or miscellaneous objects can enter and obstruct the recesses 23.

The present invention is therefore intended to obviate or at least alleviate the problems encountered in prior art.

### SUMMARY OF INVENTION

The primary objective of the present invention is to provide a storage apparatus in which tools can be securely stored and from which the tools can be conveniently taken for use.

A storage apparatus includes a box, a first cover and a second cover. The box can receive various tools. The first cover can cover the box. The first cover includes at least one hole defined therein so as to receive at least one tool. The second cover can cover the hole.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a storage apparatus according to a first embodiment of the present invention.

FIG. 2 is a partial exploded view of the storage apparatus of FIG. 1.

FIG. 3 is a side view of the storage apparatus and shows the storage apparatus in operative condition.

FIG. 4 is a perspective view of the storage apparatus according to a second embodiment of the present invention.

FIG. 5 is a perspective view of the storage apparatus according to a third embodiment of the present invention.

FIG. 6 is similar to FIG. 5 but showing the storage apparatus in an open position.

### DETAILED DESCRIPTION OF EMBODIMENTS

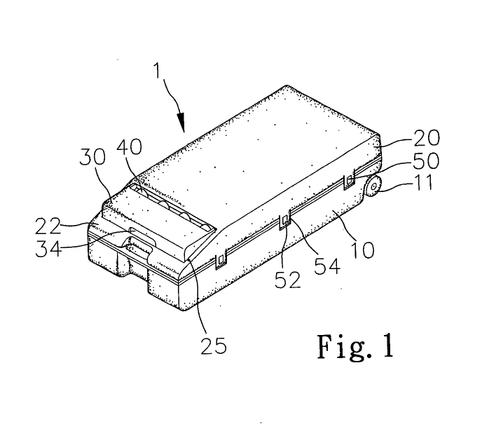

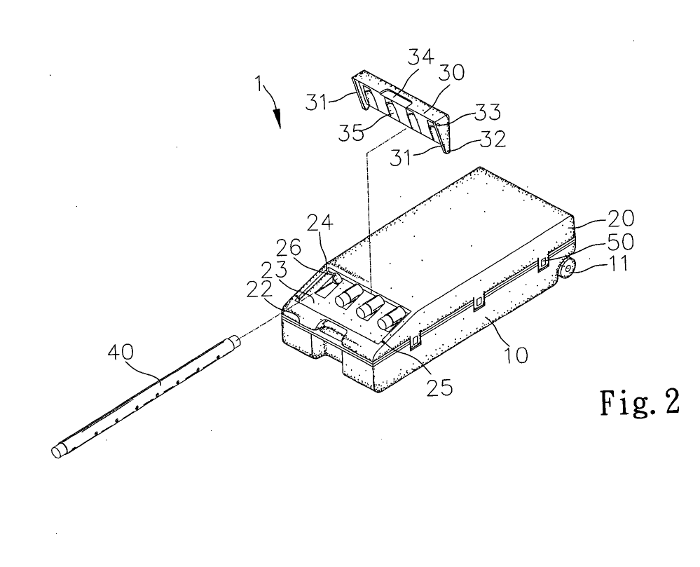

Referring to FIGS. 1 to 3, according to a first embodiment of the present invention, a storage apparatus 1 includes a box 10, a first cover 20 pivotally connected with the box 10 and a second cover 30 pivotally connected with the first cover 20.

The box 10 includes a space (not shown) defined therein. The space is used for receiving various tools. The box 10 is equipped with two wheels 11.

Several snap locks 50 are provided to lock the first cover 20 to the box 10.

The first cover 20 includes a bevel face 22 formed on a front side. The bevel face 22 of the first cover 20 includes a recess 23 defined therein for receiving the second cover 30. Two opposite walls of the recess 23 both include a bearing hole 24 and positioning hole 25. The first cover 20 includes a plurality of holes 26 defined therein. The holes 26 extend from the recess 23 toward a rear side of the first cover 20. The holes 26 are for receiving columns 40.

The second cover 30 also includes two lateral sides 31 formed thereon. A pin 32 is formed on each of the lateral sides 31 near a rear side of the second cover 30. The pins 32 are inserted into the bearing holes 24 so that the second cover 30 is pivotally connected with the first cover 20. A boss 33 is formed on each of the lateral sides 31 near a front side of the second cover 30. The bosses 33 can be forced into the positioning holes 25 so that the second cover 30 is locked to the first cover 20. Therefore, the second cover 30 can prevent the columns 40 from escaping the first cover 20. Moreover, the second cover 30 keeps dusts and miscellaneous objects from the holes 26.

The second cover 30 includes a cavity 34 defined in the front side. The cavity 34 can receive a user's fingers so that the user can easily pivot the second cover 30. The second cover 30 can be a thick plate defining semi-cylindrical grooves 35 for receiving the columns 40. Thus, the columns 40 are kept in position in the holes 26.

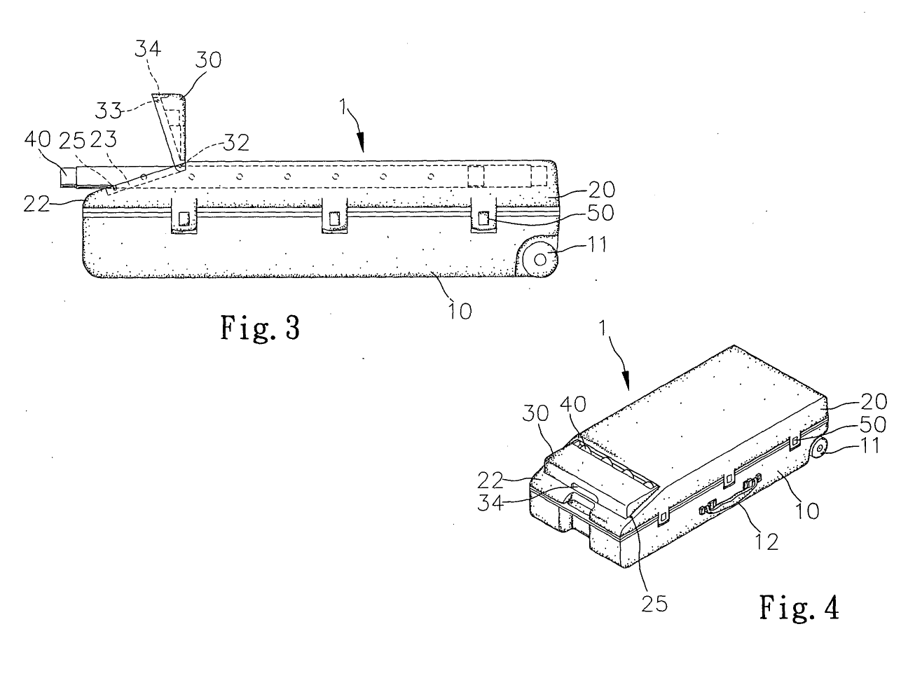

Referring to FIG. 3, the user pivots the second cover 30 from the first cover 20 so that the bosses 33 leave the positioning holes 25. Thus, the second cover 30 in an open position. The columns 40 can easily be taken from the holes 26.

FIG. 4 shows a storage apparatus according to a second embodiment of the present invention. The second embodiment is identical to the first embodiment except for including a handle 12. The user can hold the handle 12 for carrying the storage apparatus.

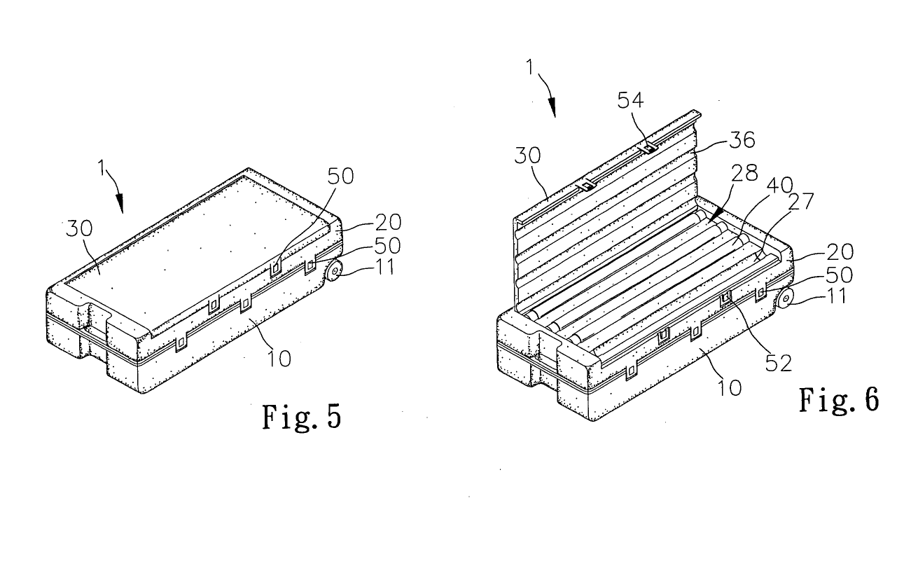

FIGS. 5 and 6 show a storage apparatus according to a third embodiment of the present invention. The third embodiment is identical to the first embodiment except for three points. Firstly, the bevel face 22 is not formed. Secondly, the first cover 20 defines a space 28 and several semi-cylindrical grooves 27 within the rectangular space 28. The space 28 can receive the second cover 30. The semi-cylindrical grooves 27 can receive the columns 40. Thirdly, the second cover 30 includes several semi-cylindrical grooves 36 defined therein for receiving the columns 40. Thus, the columns 40 are firmly retained between the first cover 20 and the second cover 30.

Several snap locks 50 are provided to lock the second cover 30 to the first cover 20. Each of the snap locks 50 includes a boss 52 formed on the first cover 20 and a lug 54 formed on the second cover 30 for hooking the boss 52.

The present invention has been described via detailed illustration of three embodiments. Those skilled in the art can derive variations from the embodiments without departing from the scope of the present invention.

Therefore, the embodiments shall not limit the scope of the present invention defined in the claims.

1. A storage apparatus including:
a box for receiving various tools;
a first cover for covering the box, the first cover including at least one hole defined therein for receiving at least one tool; and
a second cover for covering the hole:

2. The storage apparatus according to claim 1 wherein the first cover is pivotally connected with the box.

3. The storage apparatus according to claim 1 wherein the second cover is pivotally connected with the first cover.

4. The storage apparatus according to claim 1 wherein the first cover includes a bevel face from which the hole extends into the first cover.

5. The storage apparatus according to claim 4 wherein the bevel face includes a recess defined therein for receiving the second cover.

6. The storage apparatus according to claim 5 wherein the recess includes two walls each defining a bearing hole (24), and the second cover includes two lateral sides each formed with a pin inserted in one of the bearing holes.

7. The storage apparatus according to claim 5 wherein the recess includes two walls each defining a positioning hole, and the second cover includes two lateral sides each formed with a boss for insertion in one of the positioning holes.

8. The storage apparatus according to claim 1 wherein the second cover includes a cavity defined therein for receiving a user's fingers so that the user can easily pivot the second cover.

9. The storage apparatus according to claim 1 wherein the second cover includes at least one groove defined therein for receiving the column.

10. The storage apparatus according to claim 1 wherein the box includes a handle formed thereon.

11. The storage apparatus according to claim 1 further including at least one snap lock for locking the first cover to the box.

12. The storage apparatus according to claim 11 wherein the snap lock includes a boss formed on the box and a lug formed on the first cover for hooking the boss.

13. A storage apparatus including:
a box for receiving various tools;
a first cover for covering the box, the first cover including at least one groove defined therein for receiving at least one tool; and
a second cover for covering the groove.

14. The storage apparatus according to claim 13 wherein the first cover is pivotally connected with the box.

15. The storage apparatus according to claim 13 wherein the second cover is pivotally connected with the first cover.

16. The storage apparatus according to claim 13 wherein the first cover defines a space for receiving the second cover, and the groove is located within the space.

17. The storage apparatus according to claim 13 further including at least snap lock for locking the second cover to the first cover.

18. The storage apparatus according to claim 17 wherein the snap lock includes a boss formed on the first cover and a lug formed on the second cover for hooking the boss.

19. The storage apparatus according to claim 13 further including at least one snap lock for locking the first cover to the box.

20. The storage apparatus according to claim 19 wherein the snap lock includes a boss formed on the box and a lug formed on the first cover for hooking the boss.
